(19) United States
(12) Patent Application Publication
(10) Pub. No.: US 2011/0177283 A1
(43) Pub. Date: Jul. 21, 2011

(54) PET Carpet With Additive

(75) Inventor: Duane M. Juriga, Bloomfield Hills, MI (US)

(73) Assignee: FUTURIS AUTOMOTIVE INTERIORS (US), INC., Troy, MI (US)

(21) Appl. No.: 12/830,761

(22) Filed: Jul. 6, 2010

Related U.S. Application Data
(60) Provisional application No. 61/295,895, filed on Jan. 18, 2010.

(51) Int. Cl. B32B 5/12; C08G 63/91; B29C 47/78

(52) U.S. Cl. 428/97; 525/419; 264/211.17

(57) ABSTRACT

A method of forming PET fiber for carpet is disclosed. The method includes drying PET material so it has a water content of less than 50 ppm. Adding color to the PET material, heating the PET material to a temperature less than 330° C. so the PET has a viscosity between about 0.68 and 0.86, and extruding the PET through a spinneret to form fibers.

### CROSS-REFERENCE TO RELATED APPLICATIONS

This application claims the benefit of U.S. Provisional Application No. 61/295,895, filed on Jan. 18, 2010. The entire disclosure of the above application is incorporated herein by reference.

### FIELD

The present disclosure relates to carpet and, more particularly, to carpet formed of fibers containing PET and to the methods of forming PET carpet.

### BACKGROUND

This section provides background information related to the present disclosure which is not necessarily prior art.

While it is known to form carpet of PET, specific material properties of this material significantly complicate PET fiber and carpet manufacture. Because of its inherent properties, PET must be heated to reduce its viscosity to allow it to be extruded through fiber forming spinnerets. Typically, PET must be heated to temperatures above 300° C. to get the viscosity which will allow the formation of fibers having a denier of 1300 or greater. Unfortunately, above about 300° C., PET begins to degrade due to oxidation. This oxidation affects not only fiber properties, but also the manufacturing throughput.

The higher viscosity resin has a tendency to build-up residual material on the spinnerets over time, causing lower production efficiencies and higher yarn scrap (>5%) than tradition nylon yarn. The higher viscosity resin is also exposed to higher material fatigue during the extrusion process (extruder screw) which results in inconsistent knot quality and non-uniformity of crimping during the formation of the carpet. The result of these mechanical defects in the yarn translates into a non-uniform carpet “face” appearance after carpet tufting and yarn texturization. Material fatigue also causes break-downs in the physical yarn characteristics (tenacity and elongation) which also results in yarn breakage during the crimping and texturization process.

While increasing the purity of the PET may allow for a reduction of viscosity, this significantly increases the cost of raw material and precludes the use of recycled PET.

### SUMMARY

This section provides a general summary of the disclosure, and is not a comprehensive disclosure of its full scope or all of its features. To overcome some of the above deficiencies, a carpet having PET and the material to reduce the viscosity or increase the melt flow of the PET, at processing temperatures, is disclosed.

According to one aspect, a method of producing a fiber includes compounding the PET with polybutylene terephthalate (PBT) or low-molecular-weight oligomers of PBT or mixtures thereof to reduce the viscosity and processing temperatures less than 300° C. The compound is heated to a temperature of less than about 300° C. and extruded through spinnerets to form carpet fibers.

According to another teaching, PET is compounded with between 0.1% and about 5% PBT or low-molecular-weight oligomers of PBT or mixtures thereof and extruded though spinnerets in an oxygen reduced environment.

According to another aspect, PET is compounded with between 0.1% to about 3.0 weight % PBT or low-molecular-weight oligomers of PBT or mixtures thereof and heated to a temperature less than about 310° C. The heated compound is then extruded through spinnerets to form carpet fiber.

According to an alternate teaching, PBT or low-molecular-weight oligomers of PBT is compounded with PET so as to have a viscosity of between 0.68 and 0.86 at temperatures between 280° and 300° C. The compound is extruded through spinnerets at these temperatures to form carpet fiber.

According to the present teachings, any of the fibers described above can be crimped and bundled and mated with a carpet backing to form a PET/PBT carpet.

According to another teaching, a method of forming PET fiber for carpet is taught. The method includes drying PET material so it has a water content of less than 50 ppm. Adding color to the PET material, heating the PET material to a temperature less than 330° C. so the PET has a viscosity between about 0.68 and 0.86, and extruding the PET through a spinneret to form fibers. Optionally, the PET can be mixed with about 0.1% to 5.0% PBT or oligomers of PBT. This gives a material having a viscosity between about 0.68 and 0.86 at a temperature less than 330° C.

According to another teaching, PET is mixed with about 2.0 to about 3.0 weight % PBT or oligomers of PBT. The mixture is heated to a temperature where the viscosity is between 0.68 and 0.86. Fibers are extruded at temperatures where there is an acceptable or non detectable amount of degradation of the PET. Optionally, material is extruded in an atmosphere containing oxygen.

According to an alternate teaching, a method of forming PET fibers is disclosed. The method includes compounded PET with a plasticizing polymer or oligomer which reduces the viscosity of the compound between 5% to 15% at processing temperatures of between about 250° and about 330° without degradation of the carpet fiber properties at room temperature.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents a schematic of the processing of PET carpet according to the present teachings.

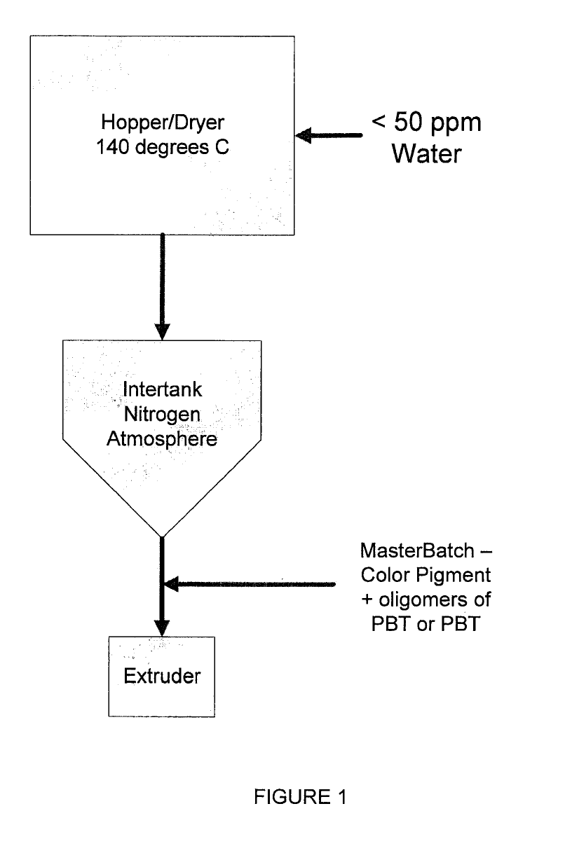

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the FIGURES. Spatially relative terms may be intended to encompass different orientations of the device in use or operation in addition to the orientation depicted in the FIGURES. For example, if the device in the FIGURES is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Refinements to the PET yarn fiber technology and finished carpet laminate described herein result in: 1) better carpet hand and appearance characteristics; 2) improved production yarn fiber manufacturing efficiencies; 3) more consistent yarn quality (uniformity and repeatability of yarn crimping and knotting); 4) reduced material yarn costs through the expanded use of multi-grade post consumer recycled PET content and; 5) more consistent color fiber uniformity and quicker color mastering.

It is envisioned PET such as (0.86 IV PET) can be mixed with about 0.1% to about 5.0%, 1.0% to about 3.0%, and particularly about 2.0% to about 3.0% PBT or oligomer such as CBT resin from Cyclics Corporation of Schenectady, N.Y. CBT is an oligomer of a cyclic form of polybutylene terphthalate (PBT). Hereinafter, references to CBT include oligomers of PBT. CBT has a low viscosity; processes well in low pressure extrusion processes, and are highly compatible with polyester thermoplastic (PET) resin. CBT is thermally stable at temperatures between 50° and 290° C. in air atmosphere and up to 370° C. in nitrogen atmosphere. According to present teachings, CBT or PBT is mixed in small percentages (0.1%-5.0%, 0.5%-3.0%, 1.0%-3.0%. or preferably 2.0%-3.0% of total resin weight) with either virgin or recycled PET resin, to enhance material melt flow characteristics and help to uniformly disperse the PET resin at processing temperatures. The optimal percentage of CBT or PBT mixed with PET resin is estimated between 0.1%-5.0% and particularly between 2.0%-3.0% of total weight.

It is anticipated that the additive may also result in slight improvements in some mechanical fiber properties such as abrasion resistance and higher heat stability. One of the major issues associated with the mass production of PET yarn fiber utilized for automotive carpet applications has been yarn breakage. The yarn breakage has typically occurred in two primary areas of the manufacturing of the yarn: 1) yarn extrusion; and 2) texturizing/crimping. It has been discovered a major contributor to yarn breakage is the material viscosity during processing of the fiber. Because of the small aperture size of carpet fiber spinnerets, small changes in material properties due to normal manufacturing tolerances of the materials and processing parameters lead to breakage of fibers. Current production PET yarn grade resin has a material viscosity of about 0.86 at about 320° C. This provides excellent material property characteristics but has presented significant process challenges with material flow and breakage. At temperatures at or above 320° C., PET begins to degrade, loosing strength, elasticity.

The introduction of CBT or PBT into the production yarn manufacturing process occurs at the fiber extrusion process as an additive to the color pigmentation master batch. CBT or PBT is an excellent base resin for master batch concentrations and also highly beneficial as a color carrier and in the dispersion of color for solution dyed PET yarn. Due to these characteristics, it will also be possible to introduce lower grades (multi-color) of post consumer recycled PET into the base yarn resin and still meet the stringent automotive material and color matching requirements. Currently only high grade (clear) post consumer recycled PET content can be utilized for automotive yarn. The cost basis for multi-color recycled PET content is roughly half the cost of either virgin or (clear) high grade recycled material. This will represent a significant cost advantage over manufacturing virgin PET yarn and also significantly increase the base feed streams for the resin.

When the CBT or PBT is heated and polymerized with the PET resin in the extrusion process, it lowers the material viscosity and thus allows a lower extrusion temperature. With the traditionally used 0.86 viscosity PET resin, the current extrusion process runs at the higher end of the operating temperatures (290°-330° C.). The CBT or PBT will considerably widen this operating range (270°-330° C.) and provide a more robust production environment. The reduced processing temperatures reduce degradation of the PET within the extruding equipment, thus improving the quality of the finished carpet. The lower temperatures and lower viscosity material will provide significant improvements in material flow and reduce material fatigue during the extrusion process.

Improved material flow will reduce PET resin build-up on the spinnerets and eliminate a lot of yarn breakage during the spinning process. Elimination of PET residue build-up on the spinnerets will also result in improved process efficiencies and reduced yarn scrap. Red material fatigue should also result in improvements to the physical mechanical properties of the spun yarn resulting in better yarn uniformity, consistency and crimping. Introduction of small amounts of CBT or PBT into the PET resin should also provide some slight improvements in material properties such as yarn strength and stiffness.

It is envisioned that the addition of oligomers of PBT will assist in the distribution of colors in the material.

TABLE 1

| | | Color | |
|---|---|---|---|
| | PBT | w/o PET | Color w/ PET |
| | Oligomers | Oligomers | Oligomers |
| Virgin PET | 0.1-3.0% | 4-6% | 3-4% |
| Clear PET | 0.1-3.0% | 4-6% | 3-4% |
| Multiclear PET | 2-4% | 4-6% | 3-4% |
| Multicolor PET | 4-6% | NA | 6-8% |

As shown in Table 2, test data for samples of various PET/PBT compounds are shown. Using a Rheomex single screw extruder, the material is mixed. The applied force (torque) is measured when the material is rotated at a constant rate (150 RPM's). The temperature of the mixing chamber of the extruder was regulated to simulate to closely resemble an intended production extrusion melt temperature range (290°-300° C.). A 1/16″ orifice was utilized at the end of the extruder.

Production intent resin (0.86 IV) was run to establish the baseline test parameters. PBT additive was then introduced in small concentrations with the PBT resin. Changes in the recorded torque was then observed.

Table 2 shows that 2.0% PBT additive utilizing baseline settings (melt temperature=293° C., RPM=150). A reduction of system torque (10,000 to 6,500 gm) was observed. Additionally noted was a reduction of extrusion pressure (3,600 to 3,500 PSI). The addition of 3.0% showed only an incremental increase in material properties. As such, the addition of between 2.0% and 3.0% of PBT to the PET allows for the improved material properties.

TABLE 2

| | | | | | | | Material Die |
|---|---|---|---|---|---|---|---|
| | IV | Amount of CBT | Melt Temperature | Mix Rate | Die Pressure | Torque | Flow |
| Trial # | dl/g | wt % | C. | RPM | PSI | mg | g/min |
| TT01054 | 0.86 | 0 | 303 | 150 | 3300 | 8000 | 123.0 |
| TT01055 | 0.86 | 2 | 303 | 150 | 3200 | 5500 | 124.7 |
| TT01051 | 0.86 | 0 | 293 | 150 | 3600 | 10000 | 131.0 |
| TT01060 | 0.86 | 0 | 293 | 150 | 3500 | 9500 | 125.9 |
| TT01061 | 0.86 | 1 | 293 | 150 | 3500 | 7000 | 124.0 |
| TT01052 | 0.86 | 2 | 293 | 150 | 3500 | 6500 | 123.7 |
| TT01053 | 0.86 | 3 | 293 | 150 | 3500 | 6500 | 123.1 |
| TT01057 | 0.86 | 0 | 285 | 150 | 3800 | 10000 | 126.0 |
| TT01058 | 0.86 | 2 | 285 | 150 | 3600 | 7000 | 125.5 |
| TT01059 | 0.86 | 3 | 285 | 150 | 3500 | 6900 | 125.3 |

IV = Intrinsic viscosity

The reduction of viscosity allows for the reduction of processing temperature to around 285° C. This reduction in processing temperature reduces material buildup on the spinnerets and breakage of fibers. The carpet created using the above described method has a carpet facing that is backed by a primary backing. The carpet facing which is the outward most layer that is seen and felt by the consumer is preferably formed of tufted PET while the primary backing is preferably polyester, a polymer fiber such as a polyolefin (PE) or any other suitable synthetic fiber. The primary backing to the carpet facing is preferably formed of a polyester or spunbonded polyesterblend scrim of 100-130 gsm. Adjacent to the primary backing is aback coating that is preferably in powder or sheet form, or any other suitable material commonly used in the art such as frothed latex or acrylic. This secondary backing is optional and may be included depending on various requirements placed on the carpeting such as moldability and sound attenuation. One skilled in the art will appreciate that the secondary backing could be omitted without straying from the scope of this disclosure.

In addition to the typical considerations for automotive carpet systems such as durability, weight, cost, sound absorption, etc., the use of recycled PET for the carpet of the present invention comes with an additional bonus feature over nylon—environmental friendliness. Utilizing the method disclosed herein, it is possible to create a “green” carpet that is mainly comprised of 100% post consumer recycled material. An example of such a carpet would mean that the carpet facing 12 is derived from recycled PET, the back coating of PE, the second backing also of PET or a spun bound polyester scrim, and the underlayment also from recycled PET. Finally, the use of recycled PET is not cost-prohibitive. Recycled PET is readily available in the material stream and in many cases provides cost advantages over both virgin resins and nylon.

While the use of the 100% recycled material is optimal and contemplated herein, this disclosure is not meant to limit the use of PET to only PET fiber that is made from 100% post consumer recycled material and anticipates that many different blends of source material may be utilized. Further, one skilled in the art will appreciate that sources of recycled material other than plastic beverage containers may also be utilized to carry out the invention.

Tufted PET for automotive carpets can be manufactured utilizing fiber diameters preferably ranging from 1200 to 2400 denier. The preferred face weight of the tufted PET can range from 9.0 oz. per 1 sq. yd. to over 50.0 oz. per 1 sq. yd. The carpet 10 can be manufactured on conventional tufting equipment as described herein, but the process preferably requires the introduction of a steaming process after the carpet has been tufted in order to develop the “hand” of the material. As described herein, the preferred method involves the introduction of a steam box or other similar heating medium to fully develop the carpet facing. During processing, the PET yarn can be tufted into any gauge, for example ⅛ or 1/10. The finer denier blends provide for a more luxurious hand appearance. At comparable carpet face weights, tufted PET has approximately 20% more tufts per square inch than conventional tufted nylon. This higher density results in improved elimination of corn rowing (or ridging) as often experienced in carpets of lower density.

Additional fiber strength and wear performance can be achieved with the tufted PET by adding additional geometry, such as looped and twisted yarns, to the fiber. Preferably, the filament count of the PET fiber is around 80 however that could vary without straying from the scope of the present invention. The fiber diameters of the tufted PET are typically finer than traditional nylon carpet and as a result, significant acoustical sound absorption advances are also anticipated by use of PET versus nylon. Micro-denier fiber technology may also allow the ability to tune interior vehicle acoustic performance at specific frequency ranges. For example, a micro-denier fiber layer (not shown) could be placed between the second backing and the underlayment to achieve different acoustic tendencies.

The present disclosure also provides for a preferred method for forming the carpet, in accordance with the preferred method of manufacture as disclosed herein, in the first step, the PET chip (either virgin or recycled) is extruded into PET yarn and then wound onto yarn cones or spools. Then in, if not already there, the yarn cones or spools are sent to the tufting location. The next step of the method involves loading the yarn cones onto a tufting creel or rewinding the yarn onto tufting beams. Then, in the yarn is pulled off of the tufting creel or beam and indexed into a tufting machine. Next, the yarn is tufted onto a primary backing. Then, in step, the carpet is steamed to develop the hand of the material. This steaming step preferably involves the use of a steam box or other similar heating medium. After tufting and steaming, in step a back coating such as a thin latex or frothed PE layer that is preferably 40-120 gms is applied to the yarn. This step “tuftlocks” the PET yarn into the primary backing.

Depending on the moldability and acoustic requirements for the carpet, an optional next step is applying a secondary back coating. This secondary back coating may consist of a polyethylene (PE) or ethylene vinyl acetate (EVA) blend. If a PE blend it preferably ranges from 200-800 gsm and if an EVA blend it preferably ranges from 800-2000 gsm. An underlayment is attached to the assembly. Finally, once the carpet is completed, it can be prepared as necessary for the specific application.

One skilled in the art will appreciate that the steps as listed above may vary or the order may change depending on the specific requirements of the carpet application. For example, the steaming may occur earlier in the process. In addition, steps may be added to the process. For example, depending on moldability and acoustic requirements for the carpet, a secondary backing can also be added. Such a secondary backing typically consists of a lightweight scrim polyester or synthetic blend and preferably ranges from 15-60 gsm.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method of producing a fiber comprising:
compounding PET with one of PBT or oligomers of PBT;
heating the compound to a temperature of less than about 310° C.; and
extruding the compound through spinnerets to form carpet fibers.

2. The method according to claim 1 wherein compounding PET is compounding PET with one of between 0.1% and about 5% PBT or between 0.1% and about 5% oligomer of PBT and extruding the compound is extruding the compound though spinnerets in an oxygen reduced environment.

3. The method according to claim 1 wherein compounding PET is compounding PET with one of between about 2.0% to about 3.0 weight % PBT or oligomer of PBT.

4. The method according to claim 1 wherein the one of PBT or oligomers of PBT is compounded with PET so the compound has a viscosity of between about 0.68 and about 0.86 at temperatures between 280° and 300° C.

5. The method according to claim 1 further comprising crimping, bundling, and mating the carpet fibers to a carpet backing to form a PET/PBT carpet.

6. A method of forming PET fiber for carpet comprising:
drying PET material so it has a water content of less than 50 μm;
adding color to the PET material;
heating the PET material to a temperature less than 330° C. so the PET has a viscosity between about 0.68 and 0.86; and
extruding the PET through a spinneret.

7. The method according to claim 6 further comprising mixing one of about 0.1 to about 5% PBT or about 0.1 to about 5% oligomers of PBT with the PET to form a compound;
heating the compound to a temperature where the viscosity is between 0.68 and 0.86 at a temperature less than 330° C.; and
extruding the heated mixture at temperatures where there is no measurable amount of degradation of the PET.

8. The method according to claim 7 wherein the material is extruded in an atmosphere containing a reduced level of oxygen.

9. A method of forming PET fibers comprising:
compounding PET with one of a polymer or oligomer which reduces the viscosity of the compound between 5% to about 15% at processing temperatures between 250° and 330° without degradation of the carpet fiber properties at room temperature.

10. The method according to claim 9 further comprising compounding the PET with between 0.1% and about 5% PBT.

11. The method according to claim 9 further comprising compounding the PET with one of between 2.0% and about 3.0% PBT or between 2.0% and about 3.0% oligomers of PBT.

12. A carpet comprising:
a plurality of crimped/bundled fibers having PET and between 0.1% and about 5.0 weight % of PBT.

13. The carpet according to claim 12 further comprising a backing material.

14. The carpet according to claim 12 wherein the fiber comprises between about 2.0% and about 3.0 weight % of PBT.

15. The carpet according to claim 12 comprising PET yarn having a diameter of between 1200 and 2400 denier.

16. The carpet according to claim 12 further comprising an underlayment layer.

17. The carpet according to claim 12 further having a face layer ranging from 9.0 oz per 1 sq yard to 50.0 oz per 1 sq yard.

18. The carpet according to claim 12 wherein the fibers comprise between 0.5 to about 3.0 weight % PBT.

19. The carpet according to claim 12 wherein the fibers comprise between 2.0 to about 3.0 weight % PBT.

20. The carpet according to claim 12 wherein the fiber is tufted into one of a ⅛ or 1/10 gauge.
